(19) United States
(12) Patent Application Publication
(10) Pub. No.: US 2017/0180224 A1
(43) Pub. Date: Jun. 22, 2017

(54) NETWORKING DEVICE MONITORING SYSTEM AND METHOD

(71) Applicant: DAWON DNS, Kwangmyungsi (KR)

(72) Inventor: Un Nam Yeo, Kwangmyungsi (KR)

(21) Appl. No.: 15/057,897

(22) Filed: Mar. 1, 2016

(30) Foreign Application Priority Data
Dec. 22, 2015 (KR) 10-2015-0179760

(51) Int. Cl. H04L 12/26; H04L 29/08; H04W 4/00; H04L 12/24

(52) U.S. Cl. CPC H04L 43/0817; H04L 41/0686; H04L 67/025; H04W 4/008

(57) ABSTRACT

The present invention provides a system monitoring a networking device and reset the same when the network device does not function properly. The system may include a remote server monitoring the power supplying device and send out a notification to a predetermined terminal about the status of the networking device.

### CROSS-REFERENCE TO RELATED APPLICATION

This application claims the benefit of Korean Patent Application No. 10-2015-0179760, filed on Dec. 22, 2015, in the Korea Intellectual Property Office and the entire disclosure of which is hereby incorporated by reference.

### FIELD OF INVENTION

Aspects of the present invention relate to devices monitoring and controlling networking devices.

### BACKGROUND OF THE DISCLOSURE

Network working devices such as wireless access points or routers have become a part of the modern life at home and work place. Wireless access points or routers connect wireless devices to LAN network. In general, wireless access points or routers are connected to LAN network and relay wireless devices and LAN network. The wireless access points or routers provide IP (Internet Protocol) to wireless devices and can transfer data packages to multiple devices.

These networking devices sometimes stop working without any particular problems on the devices themselves. Such problems could be resolved by simply resetting the devices by either initiating a resetting program or pressing a reset button on the devices.

In order to reset such devices, a user must recognize that there is a problem with a network device first and then manually reset the device. However, it is difficult to timely recognize such a problem in a networking device embedded in or connected to a device used in public place, such as Kiosk or ATM machines. Furthermore, individual users may not be able to associate a problem in network with a networking device and may have to go through multiple steps to figure out the problem.

Accordingly, there is a need of a device that remotely monitors a networking device and promptly address when the network device does not work proporly.

### SUMMARY OF THE DISCLOSURE

In a preferred embodiment, a power supplying device integrated with a network control system for controlling an external networking device has a power outlet terminal configured to be electrically connected to the networking device, a power inlet terminal configured to receive electricity from a power source, a network control system. The network control system has a control unit connected to a relay control circuit and a network module and an AC-DC converting circuit configured to convert AC received from the power inlet terminal to DC, which is supplied to the control unit and the wireless network module. The relay control circuit is configured to control electrical connection between the power source and the networking device. The network module is connected to a network through the networking device. The power supplying device monitors the network connectivity with a preset interval. For example, the connectivity may be monitored every 5-10 minutes. This can be done by sending a signal to the networking device or network element or over the network. The power supplying device may send out regularly a signal about the status of the networking device through the network with a preset interval. A remote server may monitor the regular signals to determine the operation status of the networking device. The power supplying device resets the networking device without any external direction when it determines that there is no network connection. The reset can be done a few times until the network connection is restored. The reset information is stored in the power supplying device and may be transferred to a server. The power supplying device is a standalone device, not incorporated into the networking device or connected to the networking device through wire. When the power supplying device is a standalone device, not incorporated into the networking device, the power supplying device mat be configured to be connected to the networking device through various connector system including a plug in device.

The power supplying device may be connected to a network through the networking device via wire or wirelessly. The power outlet terminal may be configured to receive a plug-in device and can be detachable. The power supplying device is a smart plug. The networking device is a device integrated with a network modem or access point, such as router, an ATM machines, network enabled kiosk, etc.

The power supplying device may reset the networking device when network disconnection is detected for a certain period of time. The reset may be done by controlling the reset protocol of the networking device or by simply disconnecting the power supplied to the networking device.

The network module of the power supplying device may be connected to the network wireless by WIFI, Bluetooth, other wireless communication connection protocol to the networking device or through a physical connection. A signal may be sent to an external server via the network connection through the network module. The external server monitors signals from the power supplying device The signal may contain identification information of the networking device, to which the power supplying device is connected. The signal may contain information regarding the operation or reset history of the networking device.

According to another preferred embodiment, a networking device monitoring system is provided. The networking device monitoring system may include a server, a networking device in a report place, a power supplying device connected to the network device where the networking device receive power from the power supplying device. The power supplying device may include a power outlet terminal configured to be electrically connected to the networking device, a power inlet terminal configured to receive electricity from a power source and a network control system. The network control system may include a control unit connected to a relay control circuit and a network module and an AC-DC converting circuit configured to convert AC received from the power inlet terminal to DC, which is supplied to the control unit and the wireless network module. The relay control circuit is configured to control electrical connection between the power source and the networking device. The network module may be connected to a network through the networking device.

The power supplying device monitors network connectivity of the networking device with a preset interval, and may send out regularly a signal to the server through the network with a preset interval between the signals. The power supplying device may reset the networking device without any external direction when it determines that the networking device is disconnected from the network for a certain period of time. The reset is done by disconnecting the power to the networking device by controlling the relay control circuit of the power supplying device. The reset may be repeated if the network connection is not restored. The server may monitor the signals from the power supplying device and notify the networking device's condition to a predetermined communication terminal. When server determines that the networking device is not connected for a certain period of time, it may notify a predetermined place for repair.

The power outlet terminal may be configured to receive a plug-in device. The networking device may be a device integrated with a network modem or access point such as a router, a ATM machine or a network enabled kiosk.

The network module of the power supplying device may be connected to the network wirelessly via WIFI, Bluetooth, other wireless communication connection protocol to the networking device or through a physical connection. The power supplying device may send a signal to an external server via the network connection through the network module.

According to another preferred embodiment, a method of monitoring a networking device is provided. The method may include providing a power supplying device connected to a networking device, regularly monitoring a network connectivity by a power supplying device in a remote place wherein the power supplying device may include a power outlet terminal configured to be electrically connected to the networking device, a power inlet terminal configured to receive electricity from a power source, and a network control system; regularly sending a signal to an external server; automatically resetting the networking device by disconnecting and connecting power supply to the network device when network disconnection is detected for a preset period; and monitoring the signals from the power supplying device and optionally sending a notification to a predetermined communication terminal. The network control system includes a control unit connected to a relay control circuit and a network module and an AC-DC converting circuit configured to convert AC received from the power inlet terminal to DC, which is supplied to the control unit and the wireless network module. The relay control circuit is configured to control electrical connection between the power source and the networking device and the network module is connected to a network through the networking device.

### BRIEF DESCRIPTION OF THE DRAWINGS

FIG. 1 illustrates a network system including a power supplying device according to one embodiment.

FIG. 2 is a block diagram illustrating a power supplying device according to one embodiment;

FIG. 3A-H illustrate various configurations of the power supplying device according to embodiments.

FIG. 4 is a flow chart illustrating monitoring and controlling a networking device with a power supplying device according to one embodiment.

FIG. 5 is a flow chart illustrating monitoring and controlling a networking device with a power supplying device according to one embodiment.

FIG. 6 is a flow chart illustrating monitoring and controlling a networking device with a power supplying device according to one embodiment.

FIG. 7 is a flow chart illustrating monitoring and controlling a networking device with a power supplying device according to one embodiment.

FIG. 8 illustrates a network system including a power supplying device according to one embodiment.

FIG. 9 illustrates a network system including a power supplying device according to one embodiment.

FIG. 10 is a flow chart illustrating monitoring and controlling a networking device with a power supplying device according to one embodiment.

FIG. 11 illustrates a network system including a power supplying device according to one embodiment.

### DETAILED DESCRIPTION OF THE PREFERRED EMBODIMENTS

Aspects of the present invention are further described in connection to the FIGURES, which only examples and do not limit the scope of the present invention. Many variations of the preferred embodiments disclosed herein can be utilized to practice the present invention.

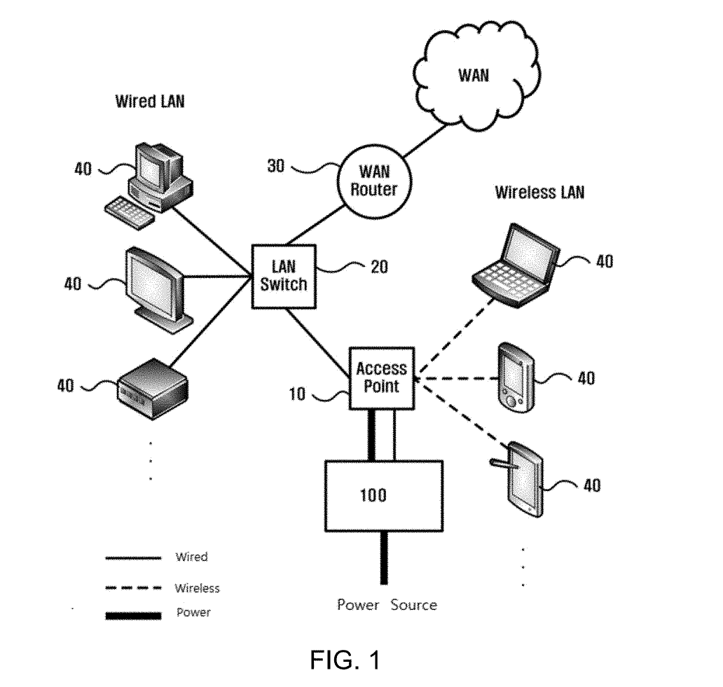

FIG. 1 illustrates a network system including a power supplying device according to one embodiment. The network system includes a wireless access point 10, an LAN switch 20, a WAN router 30, a user terminal 40, a power supplying device 100. The wireless access point 10 may be connected to one or more user terminals, forming wireless LAN network. The wireless access point 10 connects the wireless LAN network to a LAN network. The wireless access point may be connected to a LAN switch and relay data between the user terminals and the LAN switch. Through the wireless access point, user terminals can transmit or receive data to or from the LAN network. The wireless access point may be a wired or wireless IP (Internet Protocol) router and assign an individual IP address to each connected user terminal. The wireless access point may be a modem without any wireless communication function.

The LAN switch 20 may be connected through wire to the wireless access point 10 and one or more user terminals, forming a wired LAN network. The LAN switch 20 may be connected to a WAN router 30. The LAN switch 20 may relay data among the wireless access point 10, the WAN router 30 and the user terminals connected though wire.

The LAN switch 20 may include address table containing MAC (Media Access Control) address or port numbers. The LAN switch may forward data package through a corresponding port based on MAC address relating to the data package. The LAN switch may broadcast data package received to every port.

The WAN router 30 may be connected to a LAN switch. The WAN router may connect two different network, e.g. connecting a LAN network and a WAN network (e.g., internet). Through the WAN router, user terminals and the power supplying device 100 may be able to send and receive data to and from the WAN network.

The WAN router sets a communication rout between the LAN network and the WAN network. The WAN router may include a routing table and determine data package forwarding route based on the routing table.

User terminals 40 may be computer systems used by users. For example, the user terminals 40 may include but not limited to desktop computers, laptops, smartphones, tablets, kiosk, setup box, cable box, or other devices with a computer system and a communication module.

In this embodiment. the power supplying device 100 is connected to the networking device through wire. The networking device includes a device connecting between a node and a node, between a nod and a network or between a network and a network. In this embodiment, the power supplying device is connected to a network access point but can be connected to other types of networking device including a LAN switch and WAN router.

The power supplying device 100 is supplied with power from outside power source such as a power outlet and supply the power to the networking device. The power supplying device may be connected to a wired or wireless LAN network via the networking device.

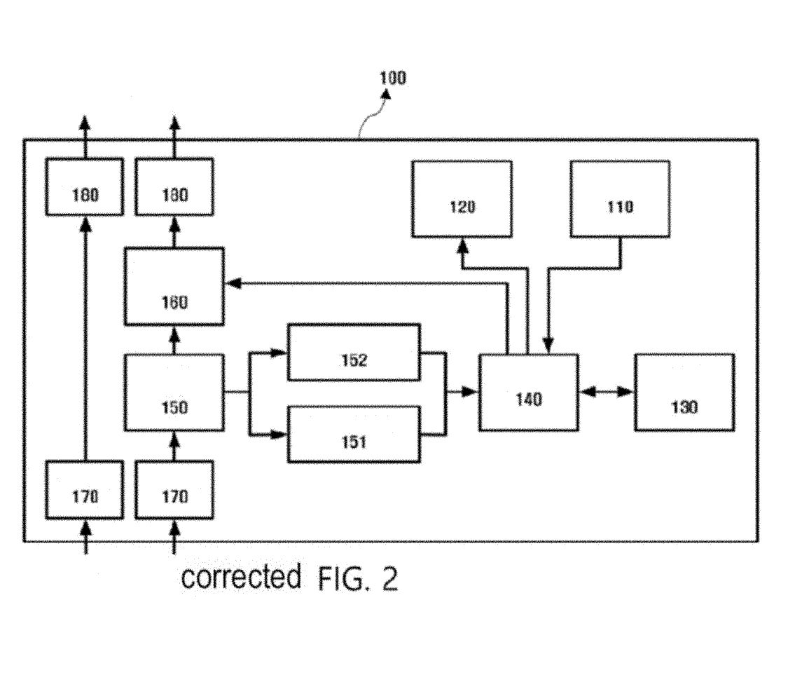

FIG. 2 is a block diagram illustrating a power supplying device according to one embodiment. The power supplying device 100 may include an input port 110, output port 120, a network module 130, a control unit 140, surge protect circuit 150, AC-DC converting circuit 151, a zero crossing circuit 152, a relay control circuit 160, a power inlet terminal 170, a power outlet terminal 180.

The input port may be used to receive commands or information from a user. For example, the input port 110 may include a button, key, touch sensor, mic, or other input mode or device and may be placed on the outside surface of the power supplying device. The input port may be used to control the power supplying device, connect the power supplying device to a communication device, or manually connect or disconnect the power supplied to the networking device.

The output port 120 may communicate various information to a user. For example, the output port 120 may include illumination device, display panel, LED, or speaker. The output port 120 may be used to indicate the status of the power supplying device, the status of connectivity to the network, or the status of power.

The network module 130 is connected to a registered device through wire or wireless and receive/send data. The network module 130 may use WiFi, WiMx, Bluetooth, ZigBee, Z-Wave or other short distance communication protocol. The network module transfer data received from a registered device to a control unit 140 and transmit data from the control unit to the registered device. The network module may include a LAN card or wireless transceiver.

The Control unit 140 controls the power supplying device's function and operation. The control unit may collect and process data and control other components in the power supplying device. The control unit may include MCU (Micro Controller Unit), CPU (Central Processing Unit), MPU (Micro Processor unit), or AP (application Processor).

The surge protect circuit 150 may be placed between the power inlet terminal 170 and the relay control circuit and protect the power supplying device and a device connected to the power supplying device from power surge.

The AC-DC converting circuit 151 converts AC power from the power inlet terminal to DC, which is supplied to the control unit.

The zero crossing circuit 152 provides timing information to the control unit in order to control the relay signal through a zero crossing method, allowing proper control of the power connection. The relay control circuit may control the relay based on a comment from the control unit and control the power connection to the power output terminal 180.

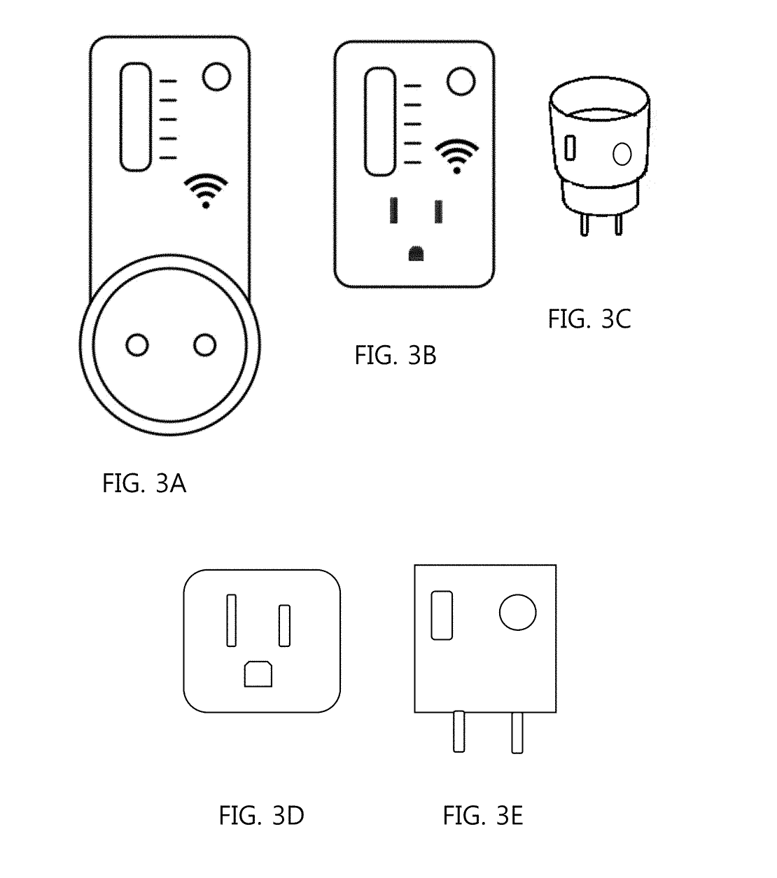

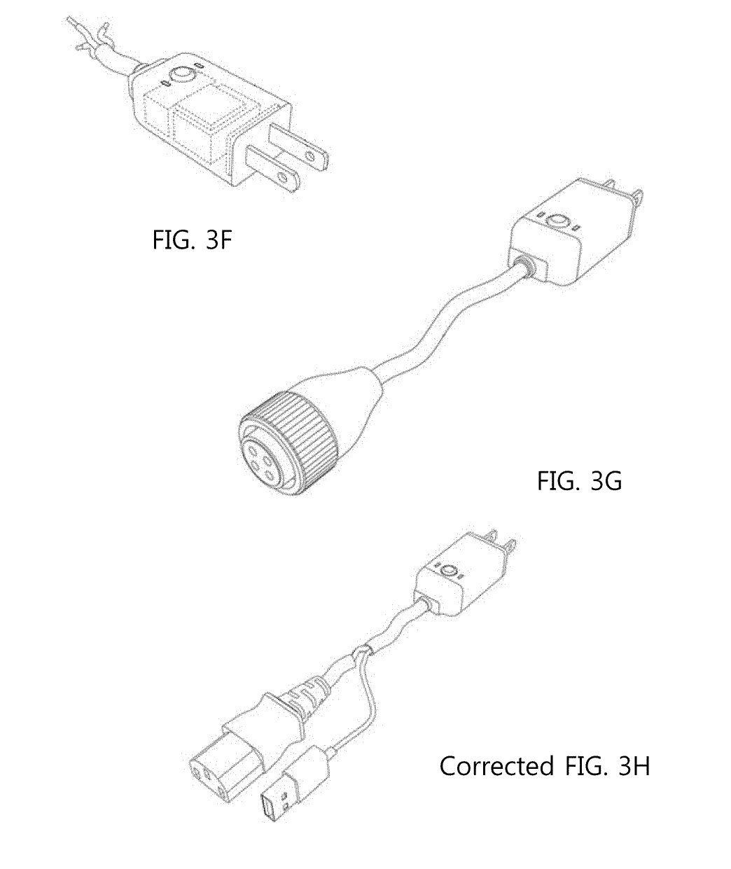

As shown in FIG. 3, deferent configurations may be adopted for the power supplying device. For example, the power supplying device may have a female power plug type portion through which a networking device is connected by plug-in. The female power plug type portion may be incorporated into the housing of the power supplying device in FIGS. 3A-E or may be formed with its own housing and connected to the power supplying device through wire as shown in FIGS. 3H-G. The power outlet or inlet terminals may be configured to be copper wires without any connecting device such as a female/male plug s shown in FIG. 3F. The power supplying device may have a male power plug portion allowing the power supplying device plug in to an outside power source. The power supplying device has its own housing allowing easy incorporating to an existing networking device.

The power supplying device may monitor the power level and may disconnect if the power level is unusually high to protect the outside device connected to the power supplying device. The power level on which the power supplying device disconnect the power can be determined and adjust by a user.

In this embodiment, the power supplying device is connected to a networking device and monitors the status of the networking device. When the networking device experiences a connectivity problem, the power supplying device detects and resets the networking device by disconnecting and reconnecting the power to the networking device. The reset process may be repeated a few times as necessary. The power supplying device may monitor the network connectivity of the networking device by sending a signal regularly with a predetermined interval through the network connection to the networking device. The power supplying device may also send signals to an outside server with a predetermined interval. When the server does not receive the signals from the power supplying device for a certain period of time, the serve notifies a designated communication terminal. The notification may be a repair request. The designated communication terminal may be a service center, a personal communication device such as a tablet or cellphone of a repair crew, or other communication device.

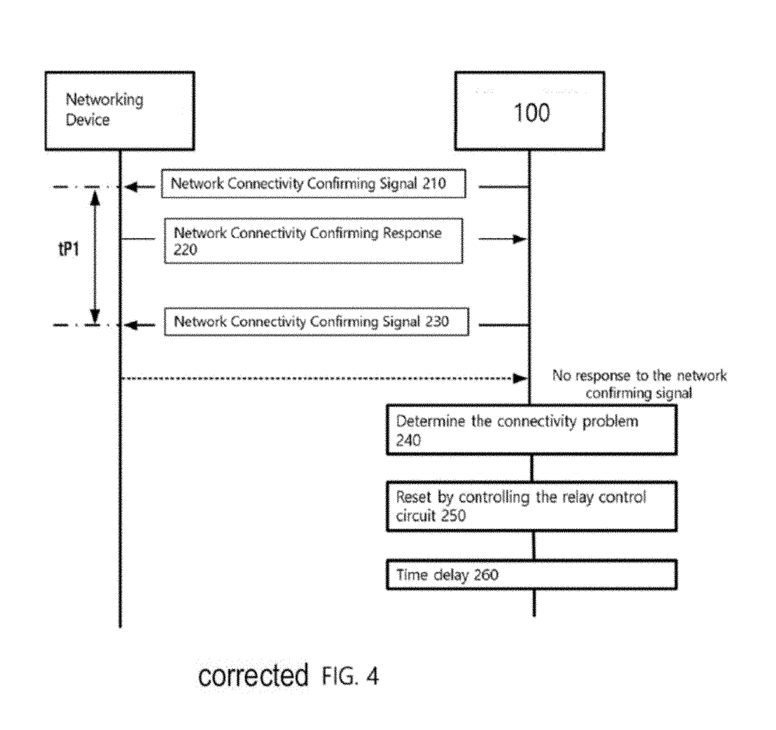

FIG. 4 illustrates monitoring and controlling a networking device with a power supplying device according to one embodiment. The step 210 relates to sending a signal to the networking device in order to test network connectivity. For example, a network connectivity confirming message may be transmitted via but not limited to a ping commend. The commend may include ICMP (Internet Control Message Protocol) echo demand. The number, size or frequency of the commend signal package may vary depending on various situations and the networking devices. In response to the network connectivity confirming message, the power supplying device receives a response from the networking device in the step 220.

When the networking device functions normally, the response is received within a normal time interval and the power supplying device determines that the networking device operates normally. This connectivity confirming steps are repeated with a predetermined interval (tP1). When the power supplying device does not receive the response for a longer period than the normal time period, the power supplying device determines that the networking device is experiencing a network communication problem. Once there is a communication problem, the power supplying device disconnect, for a preset time, and reconnect the power to the networking device by controlling the relay control circuit, resetting the networking device. Then, the power supplying device tests the connectivity again after a time delay 260. If the connectivity is reestablished, the power supplying device continues the monitoring steps. If the connectivity is not detected, the reset step is repeated. The reset and monitoring steps are repeated until the connectivity is reestablished.

The power supplying device may send a signal regularly to a remote server, which monitors the operation of the power supplying device. When the server does not receive the signal from the power supplying device for a predetermined time, it may send a notification to a predetermined terminal. The notification may include an instruction to dispatch a repair crew and information about the location of the networking device. The terminal may be a computer at a service center, a personal communication device such as a tablet or cellphone of a repair crew, or other communication device.

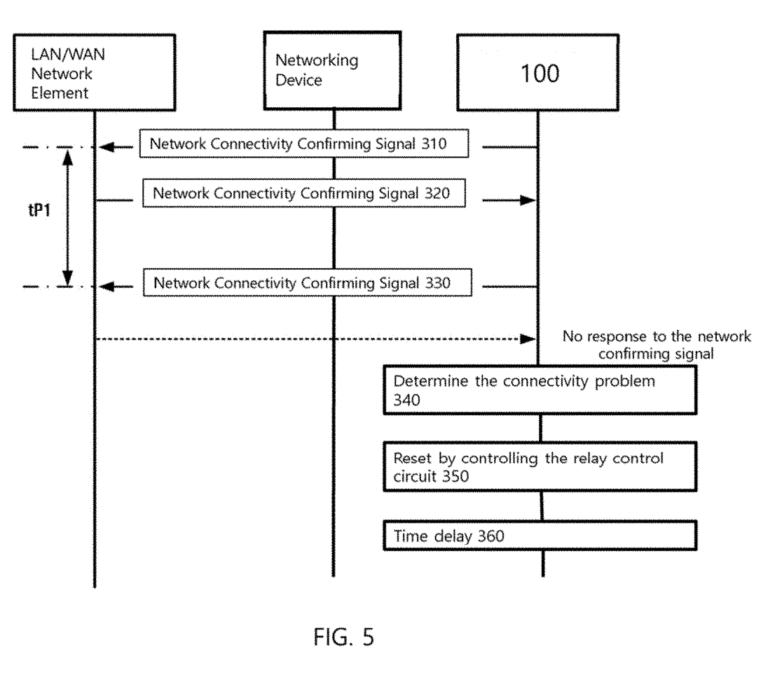

FIG. 5 illustrates monitoring and controlling a networking device with a power supplying device according to one embodiment. In this embodiment, the power supplying device sends out a connectivity confirming signal to LAN or WAN network component, not directly to the networking device and receive a response from the LAN or WAN network component. When the power supplying device is connected to an access point, the power supplying device may send the network confirming signal to a LAN switch, WAN router, a user terminal, or remote server or DNS server.

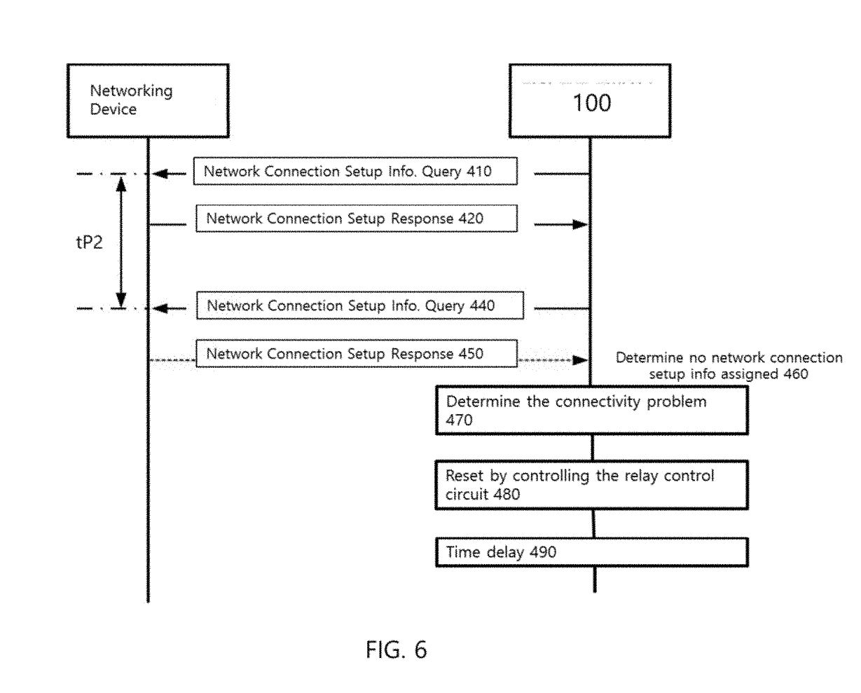

FIG. 6 illustrates monitoring and controlling a networking device with a power supplying device according to another embodiment. In this embodiment, the power supplying device requests a network setting information to the networking device in the step 410. For example, the network setting information may be sent via ipconfig commands. In this example, a response transmitted in the step 420 may be data relating to network setting values such as IP address, default gateway, serve net mask. The power supplying device analyzes the response and determines a proper network address, which is assigned to the power supplying device in the step 430. These steps are repeated with a predetermined interval tP2. When the power supplying device received an improper network setting information, the power supplying device resets the networking device. The reset step may be repeated

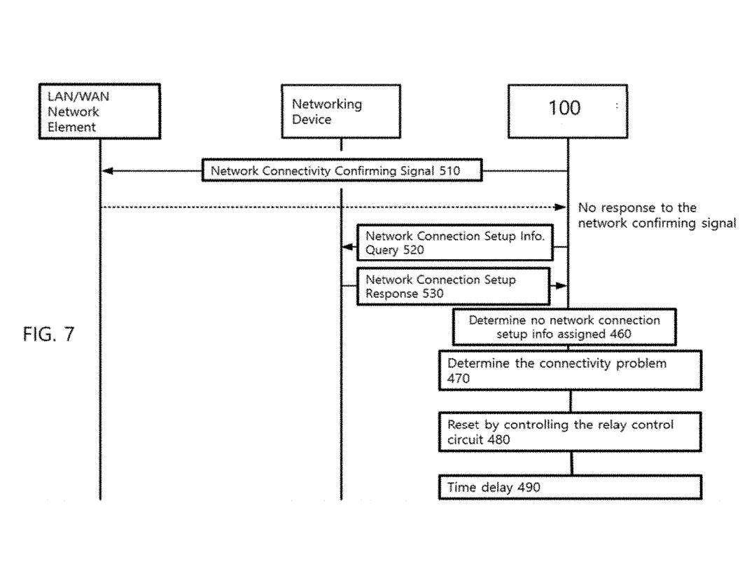

FIG. 7 illustrates another embodiment where the power supplying device send out a connectivity confirming signal to LAN or WAN network component and request a network setting information to the networking device to monitor the networking device.

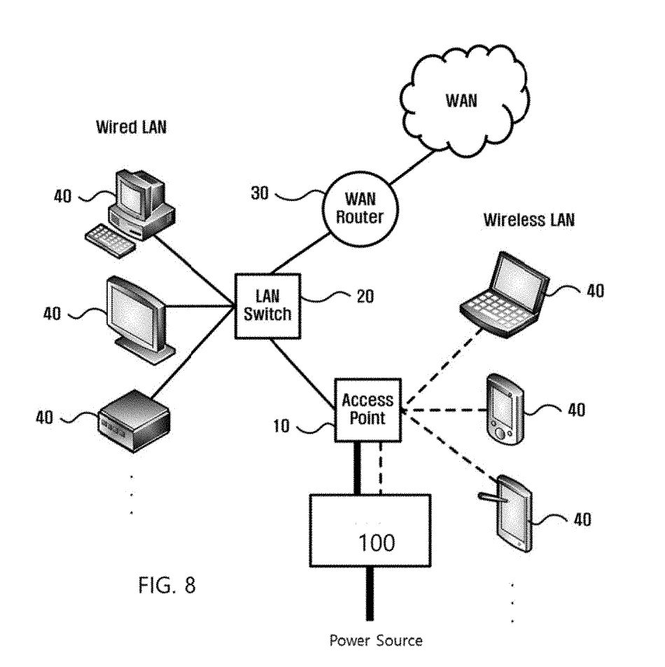

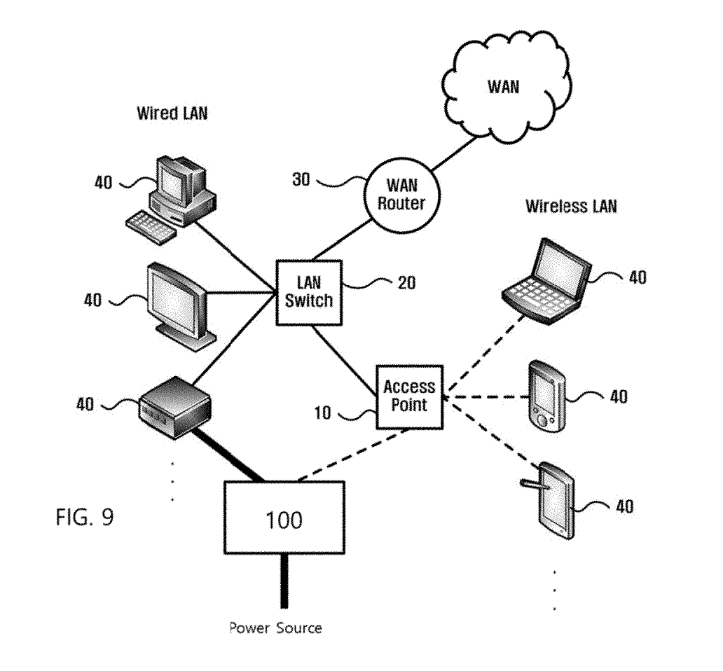

FIG. 8 illustrates a network system including a power supplying device according to one embodiment where the power supplying device 100 is connected to the networking device wirelessly. In FIG. 9, the power supplying device supplies power to a network connect device 40 and transfer data to a networking device either through wire or wirelessly. When the network connect device does not work properly. The power supplying device resets the network connect device as described herein.

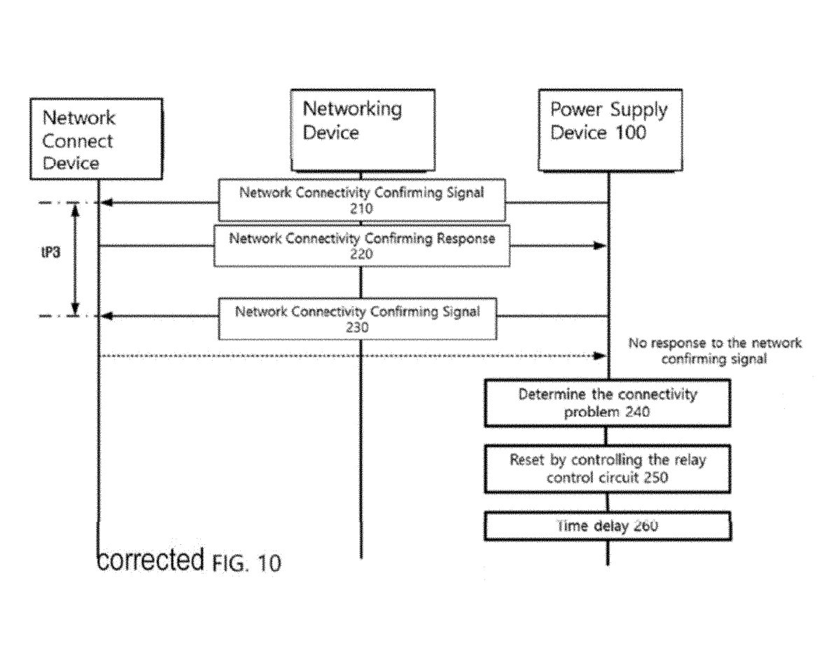

FIG. 10 illustrates another embodiment where the power supplying device send to and receive from a network connect device a network connectivity confirming signal in order to monitor the condition of the network connect device. When the network connect device does not work, the power supplying device resets the network connect device.

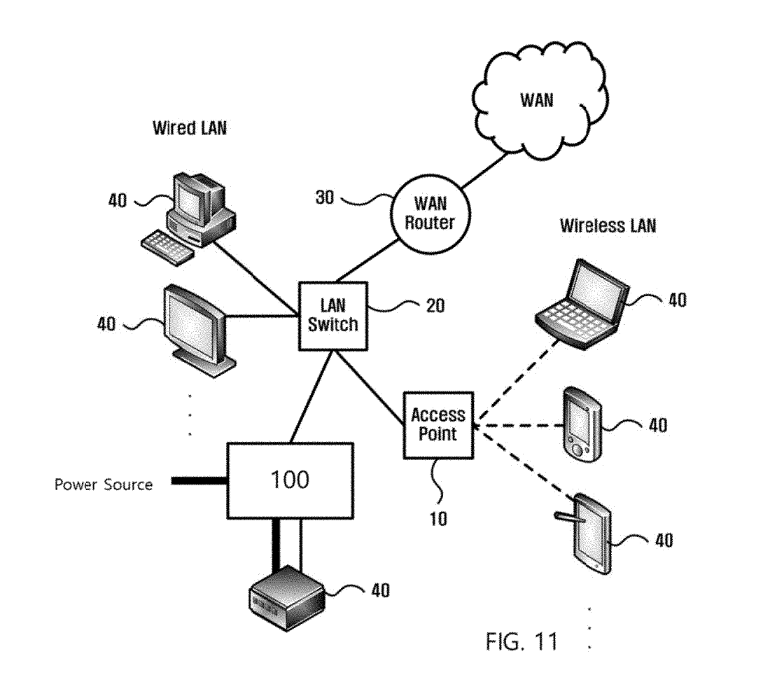

FIG. 11 illustrates another embodiment where the power supplying device is connected to a networking device through a wire connection. The power supplying device may be connected to a networking device including a wireless access point or WAN router.

The power supplying device may communicate with a remote server through the network via the networking device or through a telecommunication network such as 3G network. When the power supplying device communicates through a telecommunication network, the power supplying device may have a telecommunication module.

Since the above embodiments are described only for examples, the present invention is not limited to the above embodiments and various modifications or alterations can be easily made therefore by those skilled in the art without departing from the scope of the present invention.

What is claimed:

1. A power supplying device integrated with a wireless control system for controlling an external networking device, comprising
a power outlet terminal configured to be electrically connected to the networking device;
a power inlet terminal configured to receive electricity from a power source; and
a network control system comprising”
a control unit connected to a relay control circuit and a network module;
a zero crossing circuit and
an AC-DC converting circuit configured to convert AC received from the power inlet terminal to DC, which is supplied to the control unit and the wireless network module;
wherein the relay control circuit is configured to control electrical connection between the power source and the networking device; wherein the network module is connected to a network through the networking device; and
wherein the power supplying device is configured to monitor the network connectivity with a preset interval, send out regularly a signal through the network with a preset interval; and reset the networking device without any external direction when a preset condition is met.

2. The power supplying device integrated with a wireless control system according claim 1, wherein the preset condition is that the wireless network module is being disconnected from the network for a preset interval.

3. The power supplying device integrated with a wireless control system according claim 1, where in the power outlet terminal is configured to receive a plug-in device.

4. The power supplying device integrated with a wireless control system according claim 1, wherein the networking device is a device integrated with a network modem or access point.

5. The power supplying device integrated with a wireless control system according claim 1, wherein the networking device is a router, ATM machine or network enabled kiosk, setup box, or cable box.

6. The power supplying device integrated with a wireless control system according claim 1, wherein the networking device is reset by disconnecting and then reconnecting the power by controlling the relay control circuit.

7. The power supplying device integrated with a wireless control system according claim 1, wherein the network module is connected to the network wireless by Wifi, WiMx, Bluetooth, ZigBee, Z-Wave or other short distance communication protocol to the networking device.

8. The power supplying device integrated with a wireless control system according claim 1, wherein the network module is connected to the network through a physical connection.

9. The power supplying device integrated with a wireless control system according claim 1, wherein the signal is sent to an external server via the network connection through the network module.

10. The power supplying device integrated with a wireless control system according claim 1, wherein the server monitors the signals from the power supplying device and send a notification to a predetermined communication terminal when the signals are not received for a predetermined period.

11. A networking device monitoring system comprising
a server
a networking device in a remote place; and
a power supplying device connected to the network device where the networking device receive power from the power supplying device, the power supplying device comprising:
a power outlet terminal configured to be electrically connected to the networking device;
a power inlet terminal configured to receive electricity from a power source;
a network control system comprising:
a control unit connected to a relay control circuit and a network module;
a zero crossing circuit and
an AC-DC converting circuit configured to convert AC received from the power inlet terminal to DC, which is supplied to the control unit and the wireless network module; wherein the relay control circuit is configured to control electrical connection between the power source and the networking device;
wherein the wireless network module is connected to a network through the networking device;
wherein the power supplying device is configured to monitor the network connectivity with a preset interval, send out regularly a signal to the server through the network with a preset interval ans reset the networking device without any external direction when a preset condition is met; and
wherein the server is configured to monitor the signals from the power supplying device notify the networking device's condition to a predetermined communication terminal.

12. The networking device monitoring system according claim 11, wherein the preset condition is that the wireless network module is being disconnected from the network for a preset interval and the notification include an instruction to repair the.

13. The networking device monitoring system according claim 11, where in the power outlet terminal is configured to receive a plug-in device.

14. The networking device monitoring system according claim 11, wherein the networking device is a device integrated with a network modem or access point.

15. The networking device monitoring system according claim 11, wherein the networking device is a router, ATM machine or network enabled KIOSK.

16. The networking device monitoring system according claim 11, wherein the networking device is reset by disconnecting the power by controlling the relay control circuit.

17. The networking device monitoring system according claim 11, wherein the network module is connected to the network wireless by WiFi, WiMx, Bluetooth, ZigBee, Z-Wave or other short distance communication protocol to the networking device.

18. The networking device monitoring system according claim 11, wherein the network module is connected to the network through a physical connection.

19. The networking device monitoring system according claim 11, wherein the signal is sent to an external server via the network connection through the network module.

20. A method of monitoring a networking device, comprising
(a) providing a power supplying device connected to a networking device in a remote place wherein the power supplying device comprises:
a power outlet terminal configured to be electrically connected to the networking device;
a power inlet terminal configured to receive electricity from a power source;
a network control system comprising:
a control unit connected to a relay control circuit and a network module; and
an AC-DC converting circuit configured to convert AC received from the power inlet terminal to DC, which is supplied to the control unit and the wireless network module; wherein the relay control circuit is configured to control electrical connection between the power source and the networking device; wherein the wireless network module is connected to a network through the networking device;
(b) regularly monitoring a network connectivity;
(d) regularly sending a signal to an external server;
(e) determining the network connectivity of the networking device;
(f) automatically resetting the networking device by disconnecting and connecting the power supply to the network device when network disconnection is detected for a preset period; and
(g) monitoring the signals from the power supplying device and optionally sending a notification without a human intervention to a predetermined communication terminal when the signals are not received for a predetermined period.
